(19) United States
(12) Patent Application Publication
(10) Pub. No.: US 2015/0255890 A1
(43) Pub. Date: Sep. 10, 2015

(54) Electrical Connector For Connecting Cable

(71) Applicant: Tyco Electronics (Shanghai) Co. Ltd., Shanghai (CN)

(72) Inventors: Xiang XU, Shanghai (CN); Ming Shi, Shanghai (CN)

(73) Assignee: TYCO ELECTRONICS (SHANGHAI) CO. LTD., Shanghai (CN)

(21) Appl. No.: 14/640,932

(22) Filed: Mar. 6, 2015

(30) Foreign Application Priority Data
Mar. 6, 2014 (CN) 2014201014990

(51) Int. Cl. H01R 4/48; H01R 24/28

(52) U.S. Cl. CPC H01R 4/4836; H01R 24/28

(57) ABSTRACT

An electrical connector for releaseably connecting a cable is disclosed having a housing and a plurality of connection terminals. The housing has a plurality of receiving passages extending through the housing in a cable insertion direction. The plurality of connection terminals are each detachably positioned in the receiving passages. Each connection terminal has a terminal body having a mating end and an opposite terminating end onto which the cable is electrically connected. Each connection terminal also has a contact arm extending continuously from the mating end of the terminal body; a cable fastening member positioned on the terminating end of the terminal body; and a cable releasing member positioned on the cable fastening member.

### CROSS-REFERENCE TO RELATED APPLICATION

This application claims priority under 35 U.S.C. §119(a)-(d) to Chinese Patent Application No. 201420101499.0, dated Mar. 6, 2014.

### FIELD OF THE INVENTION

The invention is generally related to an electrical connector, and, more specifically, to an electrical connector having a reusable connection terminal.

### BACKGROUND

In electronic devices, to establish an electrical connection between two cables, the two cables are generally connected to a plug connector and a socket connector, respectively. The electrical connection of two cables is accomplished by the mutual mating between the plug connector and the socket connector.

Both the conventional plug connector and the socket connector include a housing and connection terminals mounted inside the housing. To facilitate a smooth mating operation, the cable is electrically connected to the connection terminal, where at least one terminating portion of the connection terminal is fixed to a conductor element of the cable. However, the conventional connection terminals are generally designed for single use. If maintenance is required after the insertion of the cable into the connector, the connection terminal or the whole connector generally must be replaced, creating unnecessary waste and increasing cost.

There is a need for an electrical connector having a connection terminal where the cable may be removed from the connection assembly through a simple operation, and where the connection terminal may be reused.

### SUMMARY

An electrical connector for releaseably connecting a cable has a housing and a plurality of connection terminals. The housing has a plurality of receiving passages extending through the housing in a cable insertion direction. The plurality of connection terminals are each detachably positioned in the receiving passages. Each connection terminal has a terminal body having a mating end and an opposite terminating end onto which the cable is electrically connected. Each connection terminal also has a contact arm extending continuously from the mating end of the terminal body; a cable fastening member positioned on the terminating end of the terminal body; and a cable releasing member positioned on the cable fastening member.

### BRIEF DESCRIPTION OF THE DRAWINGS

The invention will now be described by way of example, with reference to the accompanying Figures, of which:

FIG. 1 is a perspective view of a first side of a plug connector;

FIG. 2 is perspective view of a second side of the plug connector;

FIG. 3 is a schematic perspective view of a socket connector;

FIG. 4 is perspective view of a first end of a socket connector housing;

FIG. 5 is perspective view of a second end of the socket connector housing;

FIG. 6 is a perspective view of a first end of a connection terminal;

FIG. 7 is perspective view of a second end of the connection terminal;

FIG. 8 is a perspective view of the first end of the connection terminal connected to a cable;

FIG. 9 is a longitudinal sectional view of FIG. 8;

FIG. 10 is a longitudinal sectional view of the plug connector of FIG. 1;

FIG. 11 is a longitudinal sectional view of a side of the plug connector of FIG. 1;

FIG. 12 is a longitudinal sectional view of the socket connector of FIG. 3;

FIG. 13 is a longitudinal sectional view of a side of the socket connector of FIG. 3;

FIG. 14 is a sectional view of a connection state between the connection terminals when the plug connector is coupled with the socket connector; and

FIG. 15 is a schematic comparison between the contact arms of the connection terminal of FIG. 14 and a conventional connection terminal.

### DETAILED DESCRIPTION OF THE PREFERRED EMBODIMENTS

Although exemplary embodiments will be described hereinafter in detail, with reference to the attached drawings, one of ordinary skill in the art would appreciate that modifications may be made without departing from the spirit and scope of the invention. Thus, it should be appreciated that the following description is a broad teaching for those of ordinary skill in the art, and the content herein is not intended to limit the disclosure to the embodiments set forth.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

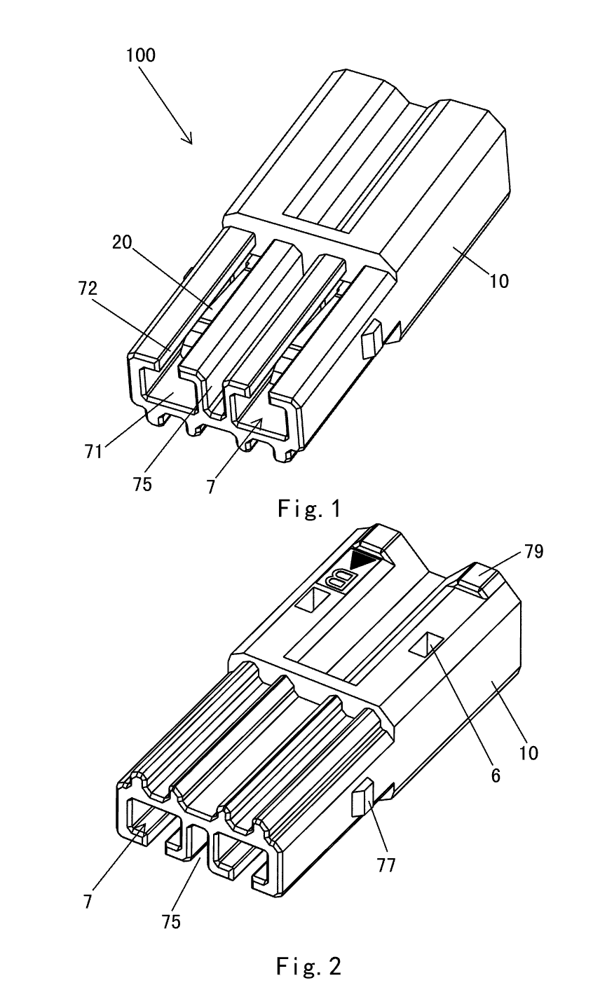

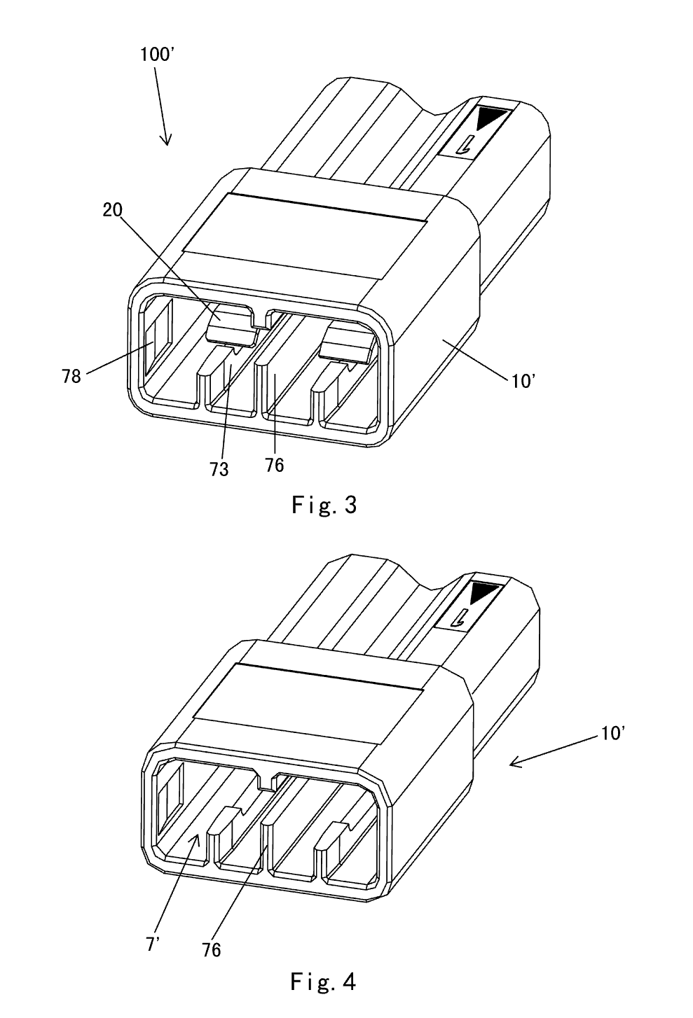

As shown in the embodiments of FIGS. 1-4, an electrical connector has a plug connector 100 for connecting a cable 300, as shown in FIGS. 1 and 2, and a socket connector 100′ for connecting a cable, as shown in FIGS. 3 and 4. In the following description, if the electrical connector is the plug connector 100, the mating connector is the socket connector 100′; if the electrical connector is the socket connector 100′, the mating connector is the plug connector 100.

The electrical connector includes: a plug connector housing 10 or 10′ and a plurality of connection terminals 20 mounted inside the housing 10 or 10′. The housing 10 or 10′ has a plurality of receiving passages extending through the housing in an insertion direction of the cable 300, where the insertion direction is along a longitudinal direction or a length direction of the electrical connector. The cable 300 is inserted into the cable receiving passage in the insertion direction.

With reference to the embodiments of FIGS. 6-9, the plurality of connection terminals 20 are made of metal sheet, such as copper, stainless steel, or other similar materials. The connection terminals 20 are detachably mounted inside the receiving passages. Each connection terminal 20 has a substantially flat terminal body 1, the cable 300 being inserted into the terminal body 1 in the insertion direction, and being electrically connected to the terminal body 1 (see FIG. 9). A contact arm 2 extends continuously from a mating end of the terminal body 1 along the insertion direction to electrically contact a complimentary mating terminal of a mating electrical connector. A cable fastening member 3 is positioned on the terminal body 1 on an opposite terminating end, and, together with the terminal body 1, grips and fixes the cable 300. A cable releasing member 4 formed on the cable fastening member 3 and constructed to operatively release the gripped cable 300.

With further reference to the embodiments of FIGS. 6-9, a cross-section of the terminal body 1 and the cable fastening member 3 on the terminating end, in a direction perpendicular to the insertion direction of the cable 300, has substantially U-shaped section, where an opening of the U-shaped section forms the cable releasing member 4. The cable 300 is separated from the connection terminal 20 through an operation of the cable releasing member 4.

In an embodiment, the connection terminal 20 has a cantilevered arm 31 extending from the cable fastening member 3 along the insertion direction, towards the mating end of the connection terminal 20. The cantilevered arm 31 extends obliquely from the cable fastening member 3 towards the terminal body 1. A free end of the cantilevered arm 31 has a sharp edge 32 for contacting the cable 300. A cable stop 11 is positioned on the terminal body 1 at a position distal to the cable fastening member 3 and proximate to the contact arm 2, limiting an insertion length of the cable 300. A conductor positioning member 12 extending in the insertion direction is positioned at a transition region between the cable fastening member 3 and the terminal body 1. After a portion of an insulation layer of the cable 300 has been removed and a corresponding portion of a conductor 301 has been exposed, the cable 300 is manually inserted into the connection terminal 20 in the insertion direction, into the substantially U-shaped space between the cable fastening member 3 and the terminal body 1. The conductor positioning member 12 assists in holding the cable 300 on the terminal body 1. When a terminating end of the cable 300 contacts the cable stop 11, the cable stop 11 prevents the cable 300 from being further displaced in the insertion direction, thus limiting the length of cable 300 inserted into the connection terminal 20.

Additionally, the terminal body 1 has at least one holding projection 14, positioned on two opposite edges respectively, which stably hold the connection terminals 20 inside the cable receiving passages of the housing 10 or 10′.

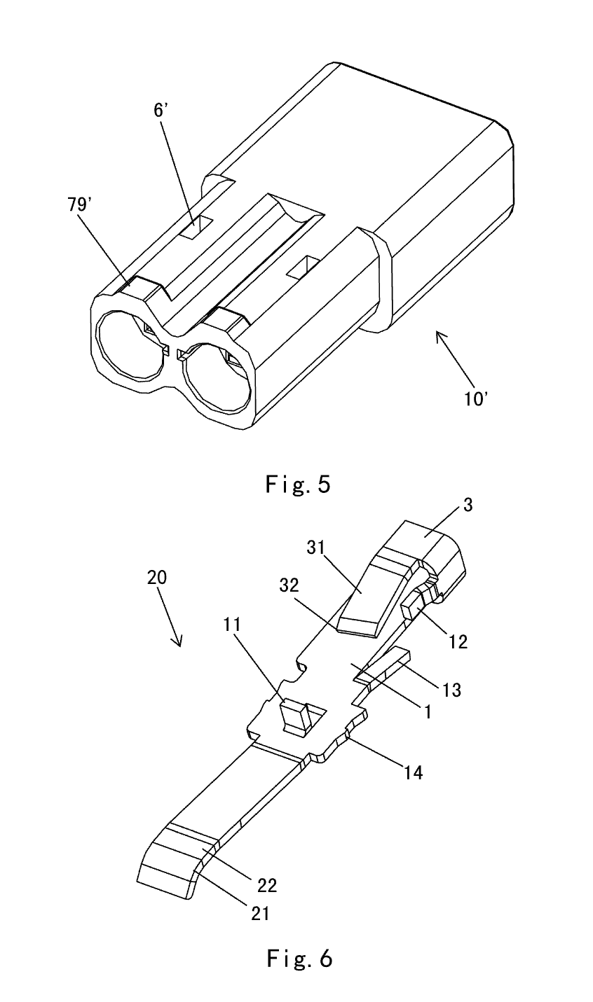

In an embodiment, the terminal body 1 includes a terminal locking member 13, which extends from the terminal body 1 towards the terminating end, opposite to the insertion direction. Correspondingly, as shown in the embodiments of FIGS. 2 and 5, the housing 10 or 10′ includes a locking member receiving hole 6 or 6′, which extends from the receiving passageway to an outer surface of the housing 10 or 10′ in a thickness direction perpendicular to the insertion direction. When the connection terminal 20 is position inside the housing, the terminal locking member 13 partially projects into the locking member receiving hole 6 or 6,' abutting against a wall of the locking member receiving hole 6 or 6′ along the direction opposite to the insertion direction. The connection terminal 20 is thus prevented from moving in the direction opposite to the insertion direction. To remove the connection terminal 20 from the housing 10 or 10′, a tool, such as a small screw-driver, may be inserted into the locking member receiving hole 6 or 6′ and pressed against the terminal locking member 13 in the locking member receiving hole. (not shown) The terminal locking member 13 may then be displaced from the locking member receiving hole 6 or 6′. In this situation, a second tool may be used to push the connection terminal 20 out of the housing 10,10′, or the cable 300 may directly pulled opposite the insertion direction so as to pull the connection terminal 20 out of the housing 10 or 10′.

As shown in an embodiment of FIG. 9, after the connection terminal 20 connected with a cable 300 is removed from the housing 10 or 10′, the cable 300 may be rotated and moved towards the opening of the cable releasing member 4, and eventually removed from the connection terminal 20. Then, after installing a new cable into the connection terminal 20, the connection terminal 20 connected to the new cable may be reinserted into the housing 10 or 10′. Alternatively, one of ordinary skill in the art would appreciate that the connection terminal 20 without a cable 300 may be inserted into the housing 10 or 10′ first, and the cable 300 may then subsequently be inserted and secured to the connection terminal 20.

As shown in the embodiments of FIGS. 11 and 12, the receiving passage of the housing 10 or 10′ has a terminal stopping protrusion 5 or 5′ therein, that is complimentary to the cable stop 11. When the connection terminal 20 is moved to a proper position along the insertion direction, the cable stop 11 of the connection terminal 20 abuts against the terminal stopping protrusion 5 or 5′ in the insertion direction, preventing the connection terminal 20 from further moving in the insertion direction. Therefore, when the connection terminal 20 is moved to the proper position, the terminal locking member 13 of the connection terminal 20 is engaged with the locking member receiving hole 6 or 6′, and the cable stop 11 is engaged with the terminal stopping protrusion 5 or 5′, such that the front-back movement of the connection terminal 20 in the longitudinal direction is prevented and the connection terminal 20 is held in the housing 10 or 10′.

The plug connector 100, as shown in the embodiments of FIGS. 1 and 2 serving as the electrical connector, and the socket connector 100′, as shown in an embodiment of FIG. 3 serving as the mating electrical connector, will be described hereinafter.

The socket connector 100′ has a plurality of socket terminals, the structures of which are the same as that of the connection terminal 20. Therefore, the connection terminal 20 described above may be used not only in the plug connector 100 but also in the socket connector 100′, reducing the manufacturing cost of the connection terminal

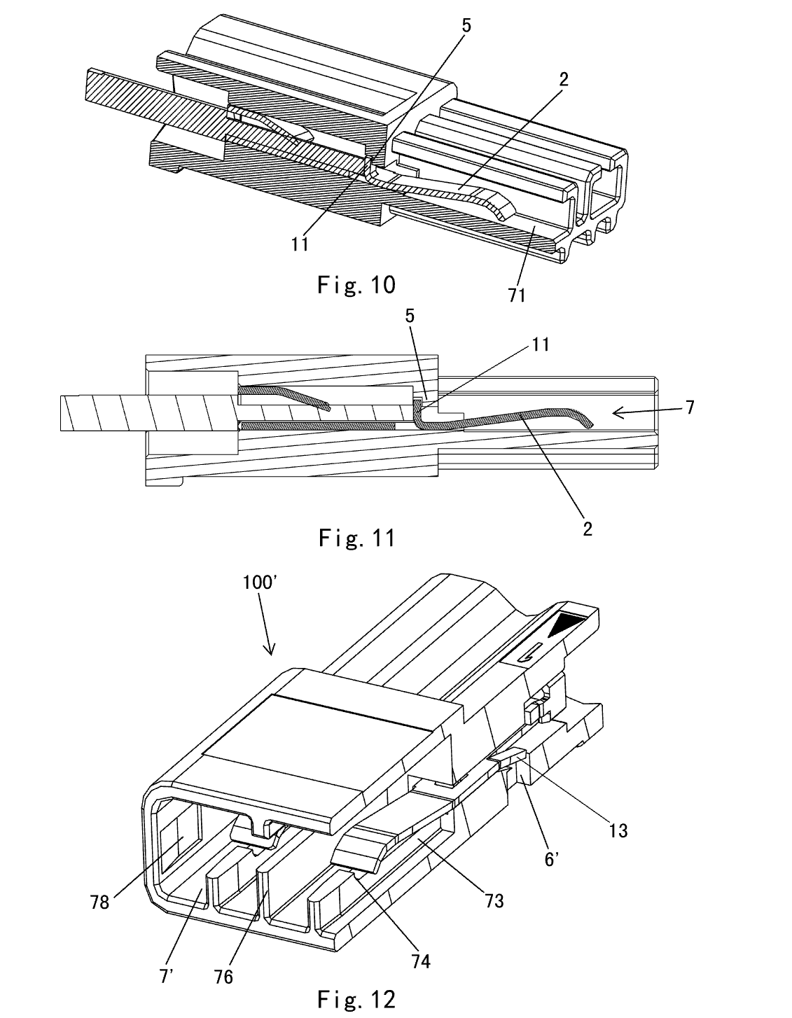

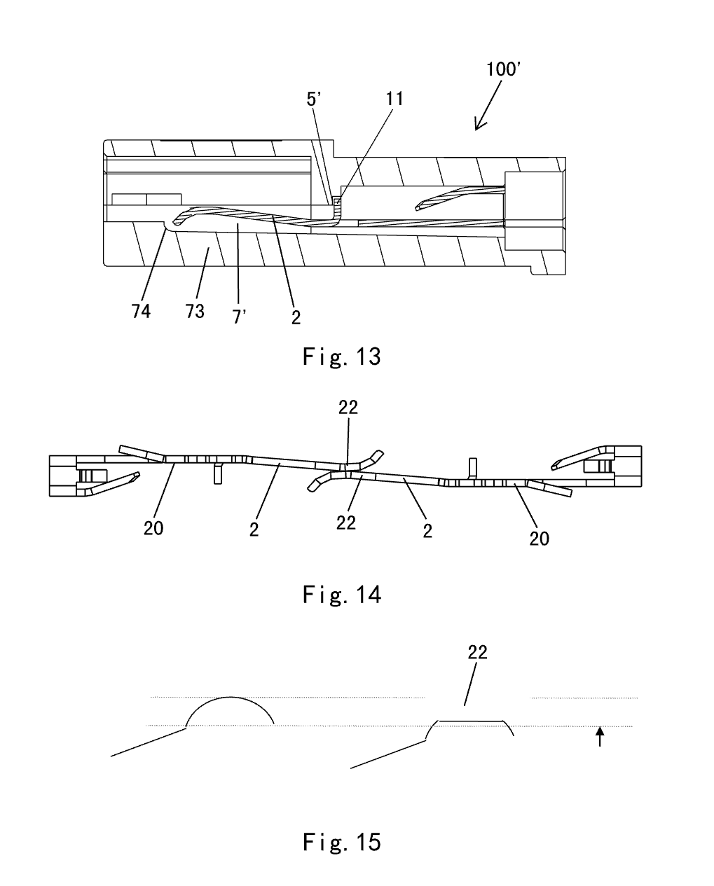

In the embodiments of FIGS. 1, 2, 10 and 11, each receiving passage of the plug connector 100 includes a terminal receiving passageway 7, in which the contact arm 2 of the connection terminal 20 is positioned. Correspondingly, as shown in the embodiments of FIGS. 3, 4, 12 and 13, the socket connector 100′ includes a plurality of socket receiving passageways 7′, in which the contact arm 2 of the connection terminal 20, serving as a socket terminal, is positioned, and into which the terminal receiving passageway 7 may be inserted such that the contact arm 2 of the connection terminal 20 is electrically connected to the contact arm 2 of the socket terminal.

As shown in the embodiments of FIGS. 1, 2, 10 and 11, the free end of the contact arm 2 of the connection terminal 20 abuts against a first wall 71 of the terminal receiving passageway 7. A guiding slot 72 extends along the insertion direction and is positioned on a second wall of the terminal receiving passageway 7 opposite to the first wall 71. Correspondingly, as shown in the embodiments of FIGS. 3, 12 and 13, a complementary guiding projection 73 is positioned on the socket receiving passageway 7′, with the contact arm 2 of the socket terminal 20 being positioned on the guiding projection 73. A contact arm stopping projection 74 is positioned on the guiding projection 73 to block the free end of the contact arm 2 of the connection terminal 20. When mating the plug connector 100 and the socket connector 100′ together, the guiding projection 73 may be displaced along the guiding slot 72 such that the contact arms 2 of the plug connector 100 and the socket connector 100′ are mechanically and electrically connected to each other.

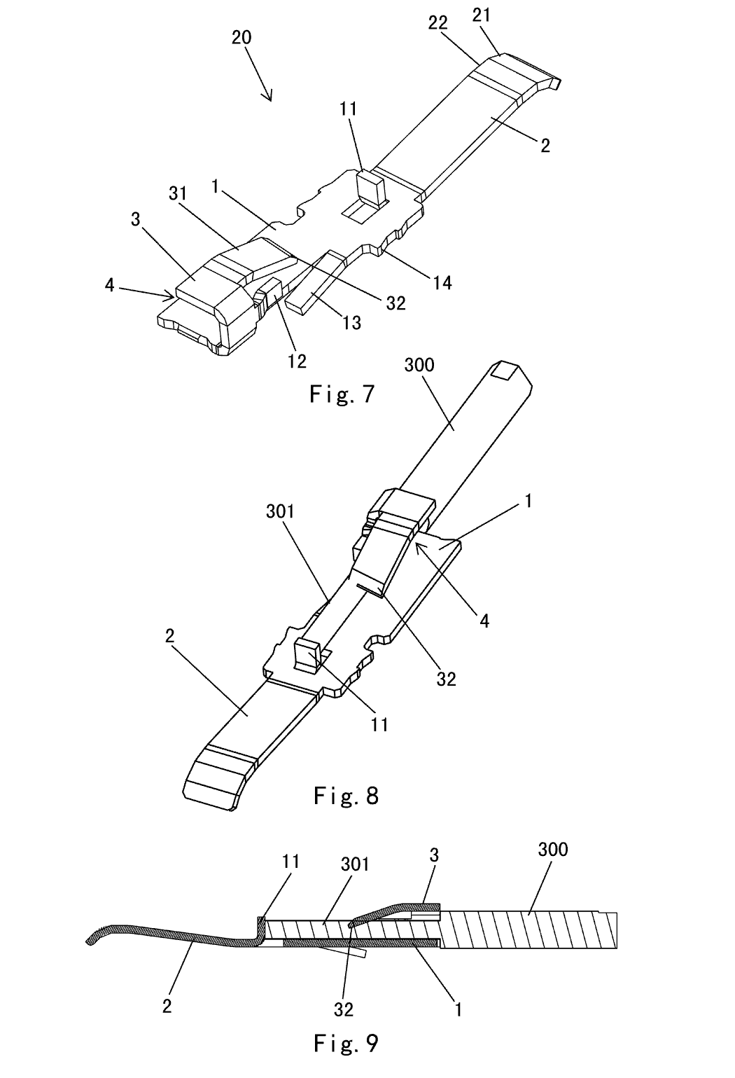

In an embodiment shown in FIGS. 6, 7 14 and 15, the free end of the contact arm 2 has an arc structure 21, and an angled, planer contact region 22 is formed in the vicinity of the arc structure 21. With reference to an embodiment of FIG. 14, when the plug connector 100 is engaged with the socket connector 100′, the contact points of the contact arms 2 are located at the planar contact regions 22. With reference to the embodiment of FIG. 15, as compared with the continuously circular arc contact region of a traditional connection terminal, the planar contact region 22 remarkably increases the contact area, preventing the contact arm 22 from undergoing excessive deformation and ensuring that the eventual contact points are located at the tilting plane contact regions 22. Consequently, a holding force generated between two contact arms 2 is greatly increased, thus increasing a plug contact force of the resultant products while preventing excessive interference between the contact arms 2.

In the embodiments of FIGS. 1, 2 and 10, a keyed groove 75 is positioned between two adjacent terminal receiving passageways 7. As shown in FIGS. 3 and 12, a complimentary keyed projection 76 is mated with the keyed groove 75, being positioned between two adjacent socket receiving passageways 7′. When the plug connector 100 is inserted into the socket connector 100′, the unique shape of the keyed projection 76 fits into the complementary keyed groove 75 and is displaced along the length of the keyed groove 75, such that the contact arms 2 of the plug connector 100 and the socket connector 100′ are mechanically and electrically connected to each other. If the keyed projection 76 cannot be positioned in the keyed groove 75, then the plug connector 100 cannot be inserted into the socket connector 100′. Therefore, the keyed projection 76 and the keyed groove 75 function both as mutual guides, as well as connector identifiers. Additionally, as shown in the embodiments FIGS. 2 and 5, a further identifying element 79 or 79′ is provided on the housing 10 or 10′, and the user may ensure whether the posture of the plug connector corresponds to the posture of the socket connector by observing the identifying elements 79 or 79′.

As shown in an embodiment of FIG. 2, a locking projection 77 is positioned on an outer wall of at least one of the two terminal receiving passageways 7 at the outermost sides. Correspondingly, as shown in the embodiments of FIGS. 3 and 12, a complimentary locking projection receiving space 78 is positioned on one of the inner walls of the two socket receiving passageways 7′ at the outermost sides, and mates with the locking projection 77. When the plug connector 100 is fully inserted into the socket connector 100′, the locking projections 77 engage the locking projection receiving spaces 78, accomplishing a snap-fit engagement between the plug connector 100 and the socket connector 100′. As such, the plug connector 100 will not be separated from the socket connector 100′ unless a large separating force is applied.

As shown in the embodiments of FIGS. 2 and 5-7, the terminal body 1 includes the terminal locking member 13, and the housing 10 or 10′ includes the locking member receiving hole 6 or 6′. When the connection terminal 20 is positioned in the housing 10 or 10′, the terminal locking member 13 partially extends into the locking member receiving hole 6 or 6′ and abuts against the wall of the locking member receiving hole 6 or 6′ in the direction opposite to the insertion direction. The connection terminal 20 is thus prevented from moving in the direction opposite to the insertion direction.

In another embodiment, the electrical connector is the socket connector 100′ and the mating electrical connector is the plug connector 100 mated with the socket connector 100′. In this situation, the plug connector 100 includes a plurality of plug terminals, the structures of which is the same as that of the connection terminal 20.

In the electrical connectors according to above various embodiments discussed above, since the connection terminal may be removed from the housing by performing a removing operation, and since the cable releasing members are positioned on the connection terminal, a cable secured in the connection terminal may be removed by a simple operation without causing any damage to the connection terminal, thereby facilitating replacement of a damaged cable with a new cable. In this way, there is no need to discard the connection terminal with the damaged cable, and the connection terminal may be reused, saving the cost of the whole electrical connector.

Those of ordinary skill in the art would appreciate that the above embodiments are intended to be illustrated. Many modifications may be made to the above embodiments by those of ordinary skill in the art, and that various structures described in various embodiments may be freely combined with each other without conflicting in configuration or principle, such that on the basis of solving the problem of the present invention, other embodiments of connection terminals may be accomplished.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. An electrical connector for releaseably connecting a cable, comprising:
a housing having
a plurality of receiving passages extending through the housing in a cable insertion direction; and
a plurality of connection terminals, each being detachably positioned in the receiving passages, and comprising:
a terminal body having
a mating end and
an opposite terminating end onto which the cable is electrically connected,
a contact arm extending continuously from the mating end of the terminal body,
a cable fastening member positioned on the terminating end of the terminal body, and
a cable releasing member positioned on the cable fastening member.

2. The electrical connector of claim 1, wherein a cross-section of the terminal body and the cable fastening member on the terminating end is substantially U-shaped in a direction perpendicular to the cable insertion direction.

3. The electrical connector of claim 2, wherein an opening of the U-shaped section defines the cable releasing member.

4. The electrical connector of claim 3, wherein the connection terminal further comprises a cantilevered arm extending from the cable fastening member along the cable insertion direction.

5. The electrical connector of claim 4, wherein, the cantilevered arm has a free end with a sharp edge that contacts the cable.

6. The electrical connector of claim 3, wherein the connection terminal further comprises a conductor positioning member positioned at a transition region between the cable fastening member and the terminal body, extending along the cable insertion direction.

7. The electrical connector of claim 1, wherein the contact arm has a free end having
an arc structure; and
an angled, planar contact region positioned in the vicinity of the arc structure.

8. The electrical connector of claim 1, wherein the terminal body includes at least one holding projection positioned on two opposite sides of the terminal body.

9. The electrical connector of claim 1, wherein a cable stop is positioned on the terminal body at a position distal to the cable fastening member and proximate to the contact arm, limiting an insertion length of the cable.

10. The electrical connector of claim 9, wherein the receiving passage has a terminal stopping protrusion that is complimentary to the cable stop, abutting against the cable stop when the connection terminal is positioned in the receiving passageway such that the connection terminal is prevented from moving in the cable insertion direction.

11. The electrical connector of claim 1, wherein the terminal body further includes a terminal locking member extending from the terminal body towards the terminating end, opposite to the cable insertion direction.

12. The electrical connector of claim 11, wherein the housing has a locking member receiving hole extending from the receiving passageway to the exterior of the housing in a thickness direction perpendicular to the cable insertion direction.

13. The electrical connector of claim 12, wherein when the connection terminal is positioned in the receiving passageway of the housing, the terminal locking member is engaged with the locking member receiving hole such that the connection terminal is prevented from moving in a direction opposite to the cable insertion direction.

14. The electrical connector of claim 13, wherein the electrical connector is a plug connector.

15. The electrical connector of claim 14, further comprising a complimentary mating connector, the mating connector being a socket connector mated with the plug connector, and the socket connector having a plurality of socket terminals with the same structure as that of the connection terminals.

16. The electrical connector of claim 15, wherein the contact arm of the connection terminal is positioned in each receiving passageway of the plug connector.

17. The electrical connector of claim 16, wherein the socket connector has a plurality of socket receiving passageways; and the contact arms of the socket terminals are positioned in each socket receiving passageway.

18. The electrical connector of claim 17, wherein when the plug connector is connected to the socket connector, each contact arm of the connection terminal is positioned in the socket receiving passageway and electrically contacts one corresponding contact arm of the socket terminal

19. The electrical connector of claim 18, wherein each receiving passageway of the plug connector has
a first wall, against which a free end of the contact arm of the connection terminal abuts; and
an opposite second wall having a guiding slot extending along the cable insertion direction.

20. The electrical connector of claim 19, wherein each socket receiving passageway has a guiding projection complementary to the guiding slot and longitudinally moveable therein, the contact arm of the socket terminal being positioned on the guiding projection.

21. The electrical connector of claim 15, wherein a keyed groove is positioned between two adjacent receiving passageways of the plug connector, and a complementary keyed projection is positioned between two adjacent socket receiving passageways, the keyed projection being mated with the keyed groove when the plug connector is connected to the socket connector.

22. The electrical connector of claim 15, wherein a locking projection is positioned on an outer wall of one of two receiving passageways of the plug connector at the outermost sides, and a complementary locking projection receiving space is positioned on an inner wall of two socket receiving passageways at the outermost sides, the locking projection being engaged with the locking projection receiving space when the plug connector is fully inserted into the socket connector.

23. The electrical connector of claim 13, wherein the electrical connector is a socket connector.

24. The electrical connector of claim 23, further comprising a complimentary mating connector, the mating connector being a plug connector mated with the socket connector, and the plug connector having a plurality of plug terminals with the same structure as that of the connection terminals.

24. The electrical connector of claim 23, wherein the contact arm of the connection terminal is positioned in each receiving passageway of the socket connector.

25. The electrical connector of claim 24, wherein the plug connector has a plurality of plug receiving passageways, and the contact arm of the plug terminal is positioned in each plug receiving passageway.

26. The electrical connector of claim 25, wherein when the socket connector is connected to the plug connector, each contact arm of the plug terminal is positioned in the receiving passageway of the socket connector and electrically contacts one corresponding contact arm of the connection terminal.

27. The electrical connector of claim 26, wherein each receiving passageway of the socket connector has a guiding projection positioned therein, with the contact arm of the connection terminal being positioned on the guiding projection.

28. The electrical connector of claim 27, wherein each plug receiving passageway has
a first wall, against which a free end of the contact arm of the plug terminal abuts, and
an opposite second wall having a guiding slot extending lengthwise, the guiding slot being complementary to the guiding projection.

29. The electrical connector of claim 28, wherein when the socket connector is mated to the plug connector, the guiding projection is positioned in the guiding slot, and is longitudinally moveable therein.

30. The electrical connector of claim 29, wherein a contact arm stopping projection is positioned on the guiding projection to block the free end of the contact arm of the connection terminal

31. The electrical connector of claim 24, wherein a keyed groove is positioned between two adjacent plug receiving passageways, and a complementary keyed projection is positioned between two adjacent receiving passageways of the socket connector, the keyed projection being mated with the keyed groove when the plug connector is connected to the socket connector.

32. The electrical connector of claim 24, wherein a locking projection is positioned on an outer wall of one of two plug receiving passageways at the outermost sides, and a complementary locking projection receiving space is positioned on an inner wall of two receiving passageways of the socket connector at the outermost sides, the locking projection being engaged with the locking projection receiving space when the plug connector is fully inserted into the socket connector.
